(19) United States
(12) Patent Application Publication
(10) Pub. No.: US 2016/0286788 A1
(43) Pub. Date: Oct. 6, 2016

(54) GAME CALL WITH TACTILE ELEMENTS TO AID FINGER PLACEMENT

(71) Applicant: Luigi Antonio Spano, Richmond Hill (CA)

(72) Inventor: Luigi Antonio Spano, Richmond Hill (CA)

(21) Appl. No.: 15/084,605

(22) Filed: Mar. 30, 2016

Related U.S. Application Data
(60) Provisional application No. 62/141,071, filed on Mar. 31, 2015.

(51) Int. Cl. A01M 31/00

(52) U.S. Cl. CPC A01M 31/004

(57) ABSTRACT

A game call is disclosed that included tactile elements on the tail portion of the insert to assist with the finger positioning of the caller to provide a consistent and repeatable call. The insert includes the a tone board and vibrating reed that is friction fit within a barrel that has a mouthpiece end for receiving air flow from a caller. The tactile elements can be either bumps or depressions, and they can be formed on the end, rim or outer surface of the tail portion of the insert. Preferably, there are three to four tactile elements to aid with finger positioning.

### FIELD

The present disclosure relates generally to a game call. More particularly, the disclosure relates to a game call that utilizes a reed and a sound board for calling water fowl, such as geese or ducks.

### BACKGROUND

Game calls have been used for many, many years by hunters. One of the most popular game calls is a duck or goose call. There is a strong market for goose and duck calls among hunters, bird watchers and call mimicry contestants. These calls are small hand-held instruments which, when mouth-blown or otherwise actuated give out sounds mimicking those of geese or ducks. Most popular goose calls are made of wood and/or synthetic plastic resin and most closely resemble a reed-type wind instrument, e.g. an oboe or clarinet.

Goose and ducks calls are constructed of two parts that are fastened together and typically have a sound board and reed arrangement. The calls consist of a barrel where the caller places their mouth and an insert that fits within the barrel that contains the reed and sound board. When the caller blows into the barrel, the reed vibrates against the sound board to produce the call.

When a caller blows the call, their on-hand holds the insert and their off-hand is placed over the on-hand, so as to cup the on-hand. The position of the on-hand with respect to the opening of the insert is critical to controlling the airflow out of the insert which in turn controls the volume and tone of the call. It is very difficult to consistently position the middle or index finger of the on-hand near the opening of the insert to control the volume and tone of the call.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a perspective view of a game call;

FIG. 2 is a perspective view of the game call of FIG. 1 disassembled to illustrate the barrel, band and insert;

FIG. 3A is a perspective view of the insert illustrating tactile bumps on the outer rim of the insert to aid finger placement;

FIG. 3B is a perspective view of the insert illustrating tactile depression on the outer rim of the insert to aid finger placement;

FIG. 4A is a view of the game call and on-hand of the caller during operation illustrating an open call;

FIG. 4B is a view of the game call and on-hand of the caller during operation illustrating an partially open call; and

FIG. 4C is a view of the game call and on-hand of the caller during operation illustrating a partially closed call.

### SUMMARY

According to a first aspect, a game call is provided that comprises a barrel having a mouthpiece end for receiving an air flow, an insert that fits into the end of the barrel opposite the mouthpiece end, the insert having a tone board and a reed that vibrates from the air flow, and one or more tactile elements on a tail portion of the insert, the tail portion near an opening of the insert to allow the air flow to exit the insert. The tactile elements assists with finger positioning on the insert to allow for consistent and repeatable finger placement. The tactile elements can either be protrusions or depressions, and can be positioned on the end of the tail portion of the insert, the rim of the tail portion of the insert, or the circumferential outer surface of the tail portion abutting the rim. Preferably, the insert includes three or four tactile elements. The insert can be retained in the barrel by a friction fitting, and the insert can include one or more O-rings to provide a seal.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the claimed invention in any way, but rather the description merely serves to provide some examples of possible embodiments.

Although some embodiments may explicitly refer to the goose or duck calls or call designs typically used for waterfowl, it will be understood by those of ordinary skill in the art that teachings described herein may be applied to other game calls that are blown and modulated using the hand of the caller. Although the embodiments described herein refer to game calls that are mouth-blown to provide air flow, it will be understood that other methods of generating air flow to actuate the game call can be used. For example, air bladders, air pumps, or other electro-mechanical means may be used to induce air flow through the call.

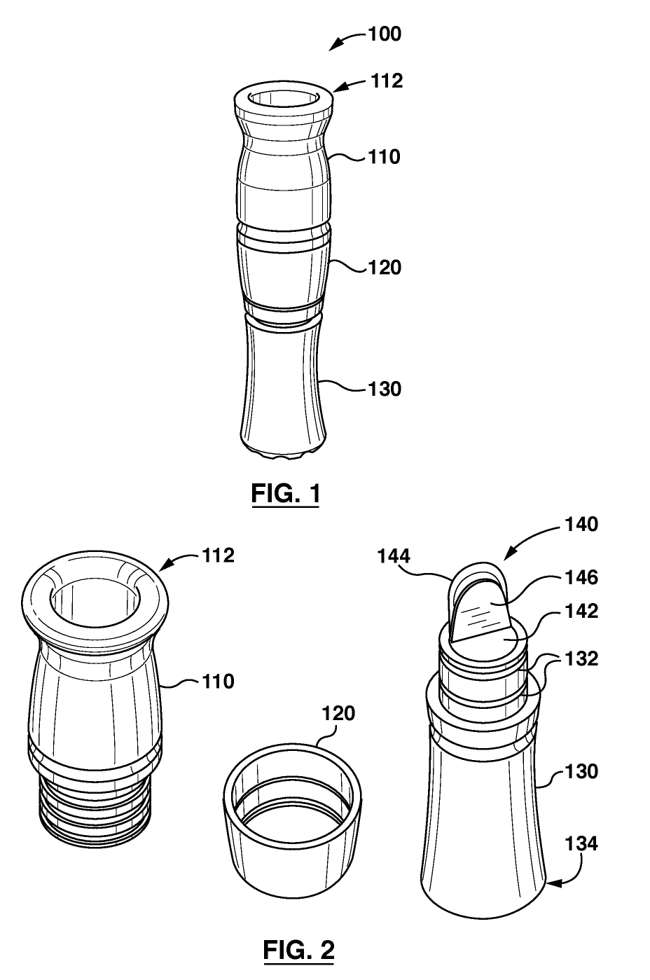

Reference is first made to FIG. 1, shown is a perspective view of the game call 100 having a barrel 110, a band 120, and insert 130. Barrel 110, band 120 and insert 130 are typically tubular and are typically held together by a friction fitting. Band 120 is decorative does not affect the sound of goose call 100, and may not be included in some embodiments. Barrel 110 has a mouthpiece end 112 through which air is forced, typically by a caller abutting their mouth to mouthpiece 112 and blowing air through barrel 110. Barrel 110, band 120 and insert 130 can be made from plastics (e.g. acrylic), wood, and/or metal.

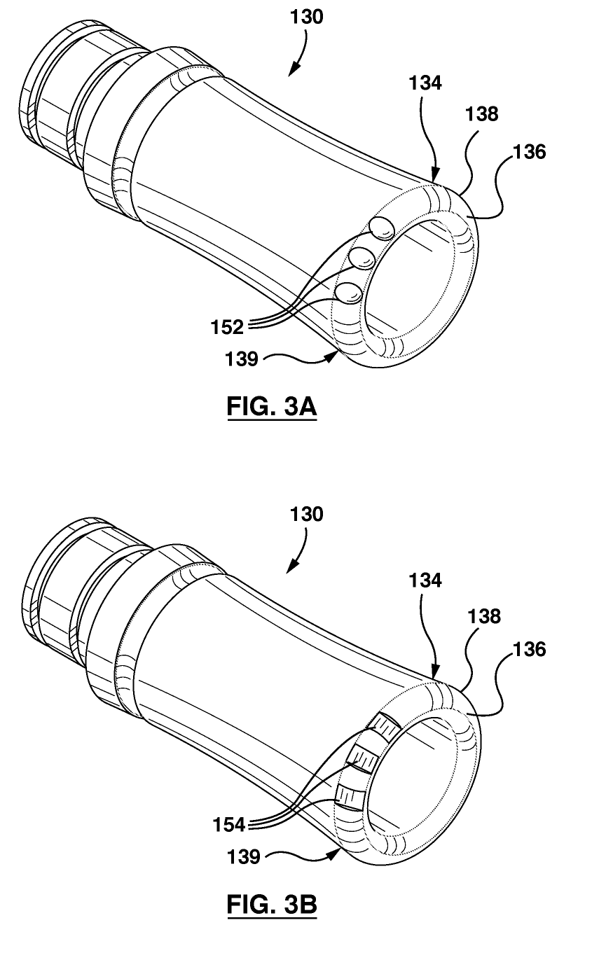

Referring to FIG. 2, a perspective view of the game call 100 of FIG. 1 is disassembled to illustrate barrel 110, band 120 and insert 130. The guts 140 of insert 130 that are contained within barrel 110 when assembled, and can be seen in FIG. 2. Guts 140 consist of the wedge 142 and tone board (or trough) 144. In a goose call embodiment, a reed 146 is placed on top of tone board 144 so the tip of reed 146 can be barely pushed down into tone board 144 and wedge 142 is placed on top of reed 146 roughly around where the reeds taper stops. In a duck call embodiment, reed 146 vibrates against tone board 144 and the reed 146 is not able to be pushed into the tone board 144. Guts 140 is pushed into insert 130 and the respective position of reed 146 and tone board 144 is secured. Insert 130 can be frictionally fit with barrel 110 so that guts 140 are within barrel 110. Insert 130 can include rubber O-rings 132 to assist in securing the fitting between barrel 110 and insert 130.

Insert 130 further comprises a tail portion 134 near where the bore of insert 130 opens to allow air to flow through (or exit) the game call 100. In some embodiments, tail portion 134 can include a bead around the circumference of tail portion 134. The embodiments illustrated herein have a chamfered or beveled edge.

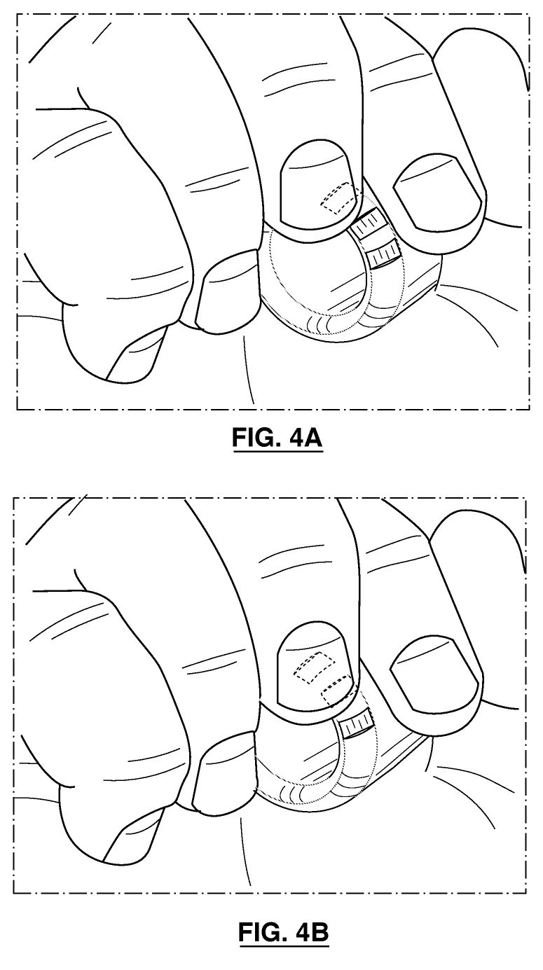

Referring to FIGS. 3A and 3B, a perspective view of insert 130 is provided to illustrate tactile elements that are included on outer surface of tail portion 134 to aid with finger placement. Tail portion 134 includes the end surface 136 of insert 130. In embodiments without a beveled rim edge, the end surface 136 is perpendicular to the circumferential outer surface of tail portion 134. In some embodiments, tactile elements 152 can be located on end surface 136.

Tail portion 134 also include the rim 138 located at the edge of the outer circumference of insert 130 at the opening. The rim 138 can also include a beveled or chamfered (or otherwise rounded) surface such as that shown in FIGS. 3A and 3B. Some embodiments can also locate tactile elements on rim 138, such as shown in FIGS. 3A and 3B. Tail portion 134 also includes a rim-abutting portion 139 along the outer circumferential surface of insert 130 near opening of insert 130. Tactile elements can also be positioned on this rim-abutting portion 139 of tail portion 134 in some embodiments.

Tactile protrusions 152 are illustrated in FIG. 3A that provide a bump that can be felt by the callers fingers. Tactile notches 154 are illustrated in FIG. 3B that provide a depression that can be felt by the callers fingers. The middle finger of the caller's on-hand rests on end 136 of insert 130 and can feel the tactile elements to assist with positioning the middle finger to control air flow and volume of game call 100. The caller will be able to feel the tactile elements with their middle finger and provide the caller with awareness of their finger position in order to precisely and consistently control the volume and air flow of game call 100.

Preferably, 3 or 4 tactile elements are provided on tail portion 134 of insert 130. Other embodiments can use a single tactile element or surround the entire circumference of tail portion 134 with tactile elements.

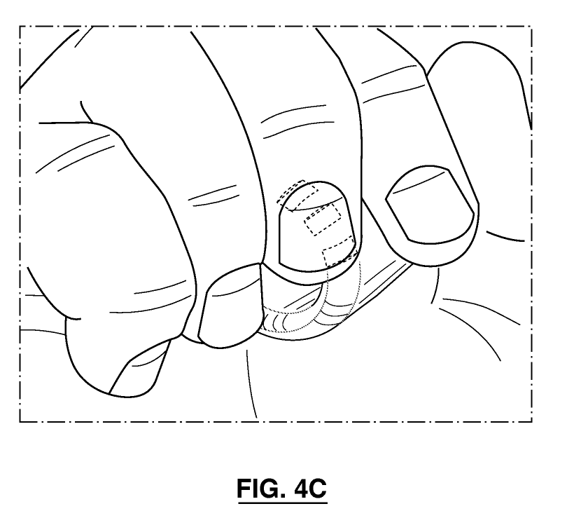

Referring now to FIGS. 4A-C, a view of game call 100 and the on-hand of the caller during operation is provided illustrating positioning of the callers finger against the tactile elements. In operation the caller blows or pushes air into game call 100 to produce different sounds to mimic geese or other waterfowl. The on-hand holds insert 130 of game call 100 and the control finger (typically the middle or index finger) is placed on end 136 or rim 138. The control finger controls the air flow and volume (or intensity of the tone). Tactile elements, such as tactile protrusions 152 or tactile notches 154, on end 136 or rim 138 allow the caller to have awareness of how much of the opening end of insert 130 is covered.

FIG. 4A illustrates the middle finger of the on-hand of the caller only engaging one of the tactile notches 154 on the side of the middle finger. The caller is aware of only engaging one of the tactile notches 154 based on feel and is able to consistently blow an open call when only engaging a single tactile notch 154, for example. FIG. 4B illustrates the side or tip of the middle finger engaging two of the tactile notches 154 to blow a partially open call, for example, and FIG. 4C illustrates the side of the middle finger engaging three of the tactile notches 154 to blow a partially closed call, for example. Tactile elements on the tail portion 134 of insert 130 aid finger placement and allow for consistent positioning of the control finger of the on-hand to control the sound of game call 100. Tactile feedback provided by the tactile elements allow a caller to make consistent and repeatable calls.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A game call comprising:
a barrel having a mouthpiece end for receiving an air flow;
an insert fits into the end of the barrel opposite the mouthpiece end, the insert having a tone board and a reed that vibrates from the air flow; and
at least one tactile element on a tail portion of the insert, the tail portion near an opening of the insert to allow the air flow to exit the insert, wherein the tactile element assists with finger positioning on the insert.

2. The game call of claim 1, wherein the at least one tactile element is a protrusion.

3. The game call of claim 1, wherein the at least one tactile element is a depression.

4. The game call of claim 1, wherein the at least one tactile element is positioned on an end of the tail portion of the insert.

5. The game call of claim 1, wherein the at least one tactile element is positioned on a rim of the tail portion of the insert.

6. The game call of claim 5, wherein the rim is any one of chamfered, beveled or rounded.

7. The game call of claim 1, wherein the at least one tactile element is positioned on a circumferential surface of the tail portion abutting the rim of the insert.

8. The game call of claim 1 further comprising two or more tactile elements.

9. The game call of claim 8, wherein there are any one of three or four tactile elements.

10. The game call of claim 1, wherein the insert is retained in the barrel by a friction fitting.

11. The game call of claim 9, wherein the insert further comprises one or more rubber O-rings.
